(19) United States
(12) Patent Application Publication
(10) Pub. No.: US 2022/0044320 A1
(43) Pub. Date: Feb. 10, 2022

(54) SYSTEMS AND METHODS FOR ANALYSIS AND ENHANCEMENT OF DATA

(71) Applicant: 60 CREEK TECH, LLC, Aurora, CO (US)

(72) Inventors: Matthew Jordan Montgomery, Aurora, CO (US); Christopher Brian Rediger, Franktown, CO (US)

(21) Appl. No.: 16/989,756

(22) Filed: Aug. 10, 2020

(51) Int. Cl. G06Q 40/04; G06F 16/9535; G06F 21/62; G06Q 10/10; G06Q 30/02; G06Q 20/12; G06Q 50/16; G06Q 30/00; G06Q 30/06

(52) U.S. Cl. CPC G06Q 40/04; G06F 16/9535; G06F 21/6227; G06Q 10/10; G06Q 30/0205; G06Q 40/12; G06Q 50/165; G06Q 30/018; G06Q 30/0645; G06Q 2220/18; G06Q 20/1235

(57) ABSTRACT

An electronic system for enhancing data includes a display device, a user input interface, a data enhancement controller, and a storage medium storing instructions that cause the data enhancement controller to retrieve a root record of a target data subject, the root record including at least one core data element, query a remote database of enhanced data elements using an electronic communication device configured to provide secure access to the remote database, create an enhanced target profile including the root record and at least one of the enhanced data elements, display, on the display device, the enhanced target profile, and display, at least one user selectable option for communicating an acquisition request to the target data subject using the enhanced target profile.

### FIELD

The field of the disclosure relates generally to analyzing and enhancing user data. More specifically, this disclosure relates to analyzing and enhancing root customer data related to mineral rights utilization.

### BACKGROUND

Harvesting of minerals, such as sedentary minerals and fluid minerals can be a great source of economic value to a property owner having a mineral right to such minerals. As used herein, the term “minerals” may refer to one or more of oil, gas, coal, metal ores, gems, salts, stone, sand or any other valuable solid or liquid natural resource located on, under or within a natural property.

As used herein, the term “mineral rights” or “mineral interest” refers to an owner having an interest or rights to explore for, develop, utilize, exploit, harvest or otherwise use any or all of the minerals they own. The owner of the mineral rights may sell, lease, donate or otherwise convey any part or portion, including the whole, of their mineral rights to any other person or company for exploitation or use.

In many instances, due to complexities of ownership of mineral rights, such as divided and undivided fractional ownerships and split depth interval ownership of mineral rights, it may not be readily determinable by a company desiring to acquire mineral rights which person or entity owns rights to such minerals. Accordingly, due to such complexities, mineral rights acquirers are subjected to highly inefficient business practices to identifying, contacting and communicating with said mineral rights owners and by such are subjected to cost prohibitive practices, ultimately, driving up the cost of such potential acquisition endeavors.

### BRIEF DESCRIPTION

In one embodiment, an electronic system for enhancing data, comprises a display device, a user input interface, a data enhancement controller, and a tangible, non-transitory, computer readable storage medium, storing instructions, which, when executed by the data enhancement controller, cause the data enhancement controller perform a number of operations. The operations include to retrieve a root record of a target data subject, the root record including at least one core data element, query a remote database of enhanced data elements using an electronic communication device configured to provide secure access to the remote database, create an enhanced target profile including the root record and at least one of the enhanced data elements, display, on the display device, the enhanced target profile, and display, at least one user selectable option for communicating an acquisition request to the target data subject using the enhanced target profile.

In another embodiment of the system, the core data element includes at least one mineral rights record.

In another embodiment of the system the instructions further cause the data enhancement controller to iteratively compare the mineral rights record to the enhanced data elements, match at least one of the compared mineral rights record to the enhanced data elements and create the enhanced target profile including at least one matched data element.

In another embodiment of the system the mineral rights record includes at least a physical location and the enhanced data elements include one or more of a social media identifier, an email address, an internet behavior profile, and demographic data.

In another embodiment of the system the remote database includes tax information associated with mineral rights owners.

In another embodiment of the system the instructions further cause the data enhancement controller to modify the root record to include a standardized data element, compare the standardized data element to the enhanced data elements, match the standardized data element to the enhanced data elements and create the enhanced target profile including at least one matched data element.

In yet another embodiment of the system the instructions further cause the data enhancement controller to receive a selected option from the user input device, and transmit the acquisition request using the enhanced target profile.

In another embodiment of the system the instructions further cause the data enhancement controller to receive a success indicator from the user input device and modify a matching protocol used to match the root record to the enhanced data elements based upon the received success indicator.

In another embodiment of the disclosure, a method of enhancing data includes providing an electronic database including a plurality of root records, each root record associated with a target data subject of a plurality of target data subjects, executing an application program interface to query a remote electronic database, the remote electronic database storing a plurality of enhanced data elements, match at least one of the root records to at least one enhanced data element of the plurality of enhanced data elements, create an enhanced target profile including the root record and the at least one enhanced data element, display, on an electronic display device, the enhanced target profile, receive, at least one user selectable option for communicating an acquisition request to the target data subject using the enhanced target profile, and communicate the acquisition request to the target data subject.

In another embodiment of the method, the acquisition request is an offer to purchase mineral rights of the target data subject.

In another embodiment of the method, the enhanced data elements include at least one of tax records, social media identifiers, email addresses, internet behavioral profiles and demographic information.

In another embodiment, the method further includes performing a verification process to determine whether the plurality of root records contains one or more inaccurate data elements, and correcting the inaccurate data elements by modifying the root record to include data from the plurality of enhanced data elements.

In another embodiment of the method, the at least one received user selectable option includes one or more of an electronically transmitted text message, an email, a physically printed document and a telephone call.

In another embodiment, the method includes receiving a success indicator that indicates whether the target data subject accepted the acquisition request.

In another embodiment, the method includes an opt-in request from at least one of the target data subjects to receive additional mineral rights acquisition data.

In another embodiment, the method includes independently querying a plurality of different remote databases, and creating the enhanced data profile by including at least one enhanced data element from each of the plurality of remote databases.

In another embodiment of the method, the acquisition request includes an offer to buy, lease or license mineral rights.

In another embodiment, the method includes receiving a response from the plurality of target data subjects, and sorting the enhanced target profiles based upon the received responses.

In still another embodiment, a tangible, non-transitory, computer readable storage medium, storing instructions, which, when executed by a data enhancement controller, cause the data enhancement controller to perform a number of operations. In this embodiment, the operations include to retrieve a root record of a target data subject from an electronic database, the root record including at least one core data element, query a remote database of enhanced data elements using an electronic communication device configured to provide secure access to the remote database, create an enhanced target profile by modifying the root record to include at least one of the enhanced data elements, display, on an electronic display device, the enhanced target profile, display, on the electronic display device, at least one user selectable option for communicating an acquisition request to the target data subject using the enhanced target profile.

In another embodiment of the computer readable storage medium, the acquisition request is an offer to purchase mineral rights of the target data subject.

### BRIEF DESCRIPTION OF THE DRAWINGS

FIG. 1 is a schematic view of a system for enhancing data according to the present disclosure.

FIG. 2 is a flow diagram of a process for enhancing data according to the present disclosure.

### DETAILED DESCRIPTION

There are a multitude of methodologies to extract minerals from a property. In the past, mining and vertically drilled wells were commonplace, and relatively inexpensive. In recent years, technologies such as horizontal drilling have resulted in substantial increases of hydrocarbon production, but such technology is very capital intensive to implement. As a result of such production increase, the mineral aggregation market is enjoying a renaissance. Mineral owners are enjoying greater liquidity of their asset, that was once an illiquid, burdensome ownership and mineral acquirers are realizing capital deployment into the commodity space with has increased efficiencies and improved return on investment.

Accordingly, the present disclosure solves the technical problem of data verification and communication that has stifled the ability for mineral rights acquisition companies to make offers to mineral rights owners. Furthermore, inefficiencies in attempts to verify and contact potential targets for acquisition forced companies to waste valuable time and resources on non-value added activities, such as sending letters and making calls to inaccurate addresses and numbers, thus resulting in a low success rate for acquiring mineral rights. The systems and methods described herein alleviate these problems, resulting in improved success rates in identifying, verifying, targeting, contacting and closing deals with mineral rights acquisition targets.

The systems and methods for analysis and enhancement of data will now be described with reference to the drawing figures.

In one embodiment, an electronic system for enhancing data 100 includes a display device 102 and a user input interface 104. The display device may be a computer monitor, screen, a high-resolution LCD, plasma, LED, or OLED panel which may be flat or curved, a cathode ray tube, or other conventional electronically controlled video monitor or the like. The user interface may include a keyboard and mouse, touchscreen, scanner, other computer peripherals adapted to input information from a user, or the like. The system 100 further includes a data enhancement controller 106, which may be a special purpose computer or a computer specially adapted to function as described herein. The data enhancement controller 106 includes or is in electronic communication with one or more processors 108 for processing software or executable commands.

The system 100 further includes memory 110, which may be a tangible, non-transitory, computer readable storage medium for storing computer executable code, software, and data. In some embodiments, the memory 110 is housed within the data enhancement controller 106. In other embodiments, memory 110 may be a remote storage device, such as a computer server or cloud storage device remotely located, but in electronic communication with data enhancement controller 106, such as via a network, LAN, WAN or internet connection. The memory 106 may include RAM, ROM or another form of storage media that stores instructions for execution by the processors 108.

In one embodiment, one or more user devices 112 may be in electronic communication with system 100, to allow individual user access and control of independent instances of software operations running thereon. User devices 112 may include laptops, computers, tablets, smartphones or other electronic user devices having a user input and display that allow system 100 to function as described herein. For example, each user device 112 may operate as a data enhancement controller 106 to run an independent instance of the operations described further herein, for example through an internet, network, wireless or other electronic communication mechanism that allows the system 100 to function as described herein. Accordingly, multiple users may access the system 100 and simultaneously and independently perform the operations as described herein.

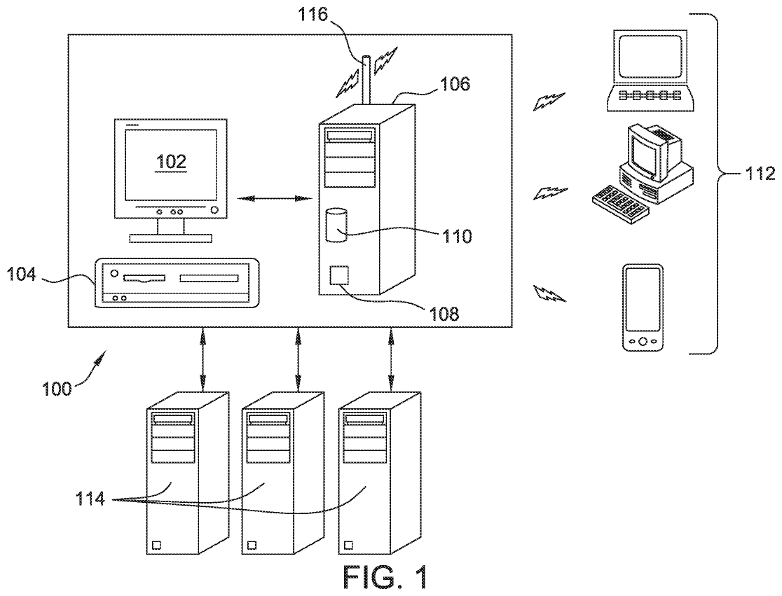

In embodiments, the system 100 is in communication with one or more remote databases 114. In order to communicate with the remote databases 114, system 100 may use an application programming interface (API) that allows secure data transfer between system 100 and the database 114. In other embodiments, a secure login, internet portal or other remote access functionality is incorporated to allow the system 10 to operate as described herein. In some embodiments, remote databases 114 are each independently owned and operated and located in locations remote from system 100. In such embodiments, system 100 may use unique APIs for each connection (represented by two way arrows on FIG. 1) to the databases 114. As used herein, the term “remote” refers to a device being physically separated from another device and having no physical direct connection to each other. The remote databases 114 may include databases storing government tax records, social media accounts, email addresses, internet behavior, demographics, addresses, phone numbers, locations of minerals, ownership of mineral rights, combinations thereof or any other data that allows the system 100 to function as described herein. In some embodiments, the remote databases 114 are owned/operated by a data aggregator, that compiles numerous data sources into a single remote database 114.

In one embodiment, a user may input one or more root records into system 100, via user interface 104 (or user devices 112) that is stored in memory 110. As used herein, each root record is an initial set of data corresponding to a target data subject, such as an individual or business entity that may own or otherwise have an interest in mineral rights that are desired for acquisition by a user. In one embodiment, the root records may include data including one or more of name, address, phone number, email address, birthdate, language, religious affiliation, number of children, marital status, property ownership status, education level, occupation, gender, household income level, length of residence, and any other demographic information that allows the system 100 to function as described herein. In one embodiment, the minimum data required, also referred to herein as a core data element, for a root record is a target data subject's name and address. In other embodiments, the core data may be any of the other data elements, as described above. In one embodiment, a user may input root records one-by-one into system 100 through user interface 104. In other embodiments, a user may have a pre-populated file or database containing a plurality of root records that may be uploaded to system 100 in order to more rapidly have the root records entered and saved into system 100.

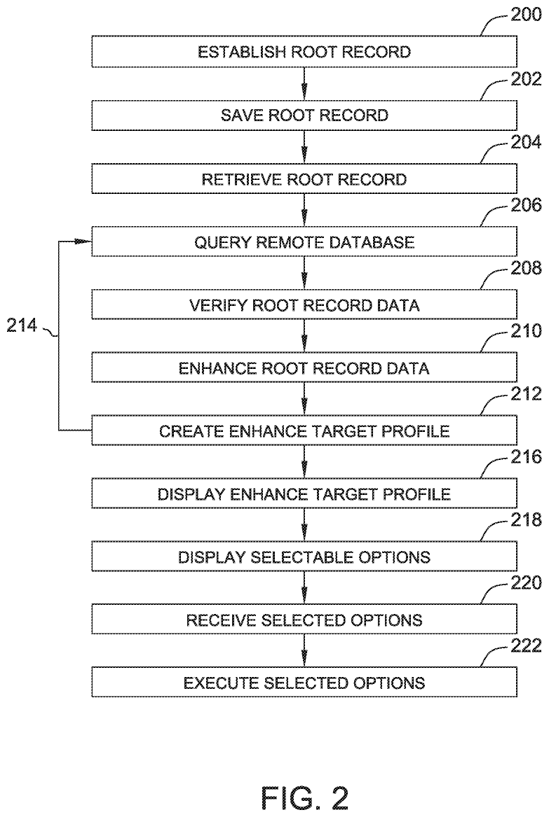

With additional reference to FIG. 2, in one embodiment, once a root record has been established 200, the root records are stored 202 at memory 110.

In one embodiment, the memory 110 stores computer readable (e.g., executable) code (i.e., instructions), which, when executed by the data enhancement controller 106, cause the data enhancement controller 106 to perform one or more special purpose operations adapted to allow the system 100 to function as described herein.

In one embodiment, the instructions are executed to retrieve a root record 204 of a target data subject stored in memory 110. In this embodiment, the root record includes at least one core data element, such as the target data subject's name and/or address. At this stage, the user of system 100 may not be confident that the core data elements are correct, and also may not have other information such as an email address, telephone number, email address or other contact information of the target data subject desired by the user in order to contact the target data subject. Accordingly, the user may continue to have the system 100 execute the instructions to verify and enhance (e.g., add/modify additional data elements) the root records.

Accordingly, in one embodiment, the instructions are further executed by data enhancement controller 106 to query 206 a remote database 114 of enhanced data elements using an electronic communication device 116 configured to provide secure access to the remote database. For example, the secure communications device can include a modem, LAN, WAN, cellular data or other electronic communication device that allows the system 100 to function as described herein. Security across the communication to the remote database may include encryption or the like of the data to prevent unauthorized access of the data at rest and in transit.

At the remote database 114, the data enhancement controller 106 will access one or more enhanced data elements, such as government tax records, social media accounts, email addresses, internet behavior, demographics, addresses, phone numbers, locations of minerals, ownership of mineral rights, name, address, phone number, email address, birthdate, language, religious affiliation, number of children, marital status, property ownership status, education level, occupation, gender, household income level, length of residence, or combinations thereof. In one embodiment, the data enhancement controller queries remote database 114, which is a tax roll database. In this embodiment, the tax roll records stored in remote database 114 are compared to one or more of the core data elements of the root records. In the event the data enhancement controller 106 matches a core data element to data from the remote database 114, for example, the core data element John Smith is matched to a John Smith from the remote database, the data controller may indicate the core data element to be verified (i.e., correct) 208. In other embodiments, the data enhancement controller 106 may be set to require multiple core data elements to be matched to data from the remote database 114 prior to being indicated as verified 208. In the event that the root record cannot be matched to a data element in the remote database, the root record may be indicated to be unverified. In one embodiment, the data enhancement controller 106 performs the data verification operation for each root record.

In some embodiments, data enhancement controller may provide error correction of the core data elements prior to performing the matching. For example, in some embodiments, the core data elements may contain a misspelling or other error. For example, a user may have mistyped John Smith as Jhon Smith. In such an embodiment, data enhancement controller 106 may analyze the core data element and determine that “Jhon” is a potential misspelling of “John.” In this embodiment, data enhancement controller 106 may automatically update the core data element with the proper spelling to correct the error. In other embodiments, data enhancement controller 106 may cause display device 102 to display the error to the user, and provide a user selectable option to perform the error correction on the core data element or to leave the core data element uncorrected.

In one embodiment, after the root record data has been verified 208, the instructions further cause the data enhancement controller to perform a data enhancement operation 210 on the verified root records. During the data enhancement operation 210, the data enhancement controller 106 accesses one or more enhanced data elements from the remote database 114 and modifies the root record to further include the enhanced data element, thus creating an enhanced target profile that includes at least the core data from the original root record and at least one of the enhanced data elements. For example, in one embodiment, the remote database 114 is a database storing a plurality of email addresses referenced to one or more core data elements. In this example, once the core data element of the root record is verified, the data enhancement controller 106 modifies the root record to further include the email address associated with the core data element from the remote database to create an enhanced target profile 212.

In one embodiment, the instructions include a progressive data enhancement process 214, whereby the instructions cause the data enhancement controller 106, upon creation of the initial enhanced target profile 212, to then further query an additional remote database 114. In this embodiment, the processes to verify root record data 208 and enhance root record data 210 are conducted with respect to the additional remote database 114. In the event the core data element is verified 208, additional enhanced data elements are pulled from the additional remote database 114 and added to the enhanced data profile 212. This progressive data enhancement process 214 may continue for as many remote databases as are available to system 100, or for only such remote databases 114 as are instructed to be queried by a user, for example via an input to user input 104.

In one embodiment, upon creation of the enhanced target profiles 212, the enhanced target profile(s) are displayed 216 on the display device 102.

In one embodiment, after the enhanced target profiles have been created 212 and/or displayed 216, the user may be presented with one or more user selectable options for communicating an acquisition request. As used herein, an acquisition request (i.e., offer) may include an offer to buy, lease or license mineral rights from a target individual. In one embodiment, the user selectable options for activities associated with the enhanced target profiles, and include one or more of email communications, telephone communications, text message, ringless voicemail, social media, post cards, letters or combinations thereof. Each of the user selectable options may include a price per activity per enhanced target profile. The user may select one or more of the user selectable options for each enhanced target profile individually, or the user may group or select all of the enhanced target profiles and have the user selected options apply to such grouping. In this embodiment, the user uses user input interface 104 to input the selected options to system 100. The user selectable options may be referred to as a campaign, or marketing campaign in some instances.

In embodiments, each of the activities associated with the user selectable options includes a communication related to a mineral rights acquisition request. In some embodiments, the communications may be transmitted to the appropriate communication channel (e.g., telephone, text, mail, etc.) of the enhanced target profile, by electronic communications or physical documents, depending upon the user selected options. In some embodiments, together with the electronically communicated acquisition requests, each request may include a target selectable option of a success indicator that is transmitted back to data enhancement controller 106, such as to accept an offer, receive more information, receive a reduced amount of communication, or halt communications. For physical documents, such documents may include a return document that the target may complete and mail back to the user to be entered into system 100 via user interface 104 to indicate the target would like to accept an offer, receive more information, receive a reduced amount of communication, or halt communications.

In some embodiments, the user selectable options may include an input option for a starting and ending date for the campaign. In such embodiment, the user may use user input interface 104 to select any date in the future as a start and/or end date for the campaign. The start date may be applied to each user selected option individually, or as a whole, depending on whether the user desires to have each selected communication option start/end on the same dates or different dates applicable to each selected option individually.

Upon receipt of the selected options and the start date, and optionally end date, the system 100 will then execute 222 the selected options for the user's marketing campaign. As used herein, execute the marketing campaign means that the selected user options for the communications are appropriately addressed and sent to the individuals associated with the enhanced target profiles. In some embodiments, the user may be presented with an option for recurring execution of one or more of the communications associated with the marketing campaign. For example, the user may select that one or more of the communications be repeated on a regular or intermittent basis, as selected by the user.

In some embodiments, the system 100 receives one or more success indicators associated with each individual associated with the enhanced target profiles. If a target selects the option to accept the offer or to receive more information, the enhanced target profile may be modified to include an indication that the communication was successful. Whereas, in the event the target selects to receive fewer communications, halt communications or does not respond at all, the enhanced target profile may be modified to include an indication that the communication was unsuccessful. The data enhancement controller 106 may aggregate the success rates and determine rates of success by marketing communication type, and present the user at display 102 with a numerical or graphical representation of which communication types have resulted in the highest success rates. Accordingly, the system 100 can improve the efficiency of the user's marketing campaigns by allowing the user to, for example, focus future marketing campaigns on the communication types resulting in the highest success rates.

In some embodiments, prior to querying the remote database 206 operation, the instructions cause the data enhancement controller 106 to modify the root record to include a standardized data element, such as a standardized address format. In this embodiment, the root record is then updated to include the standardized data element, and the data enhancement controller 106 compares the standardized data element to the enhanced data elements during the verification of root record data operation 208, match the standardized data element to the enhanced data elements and create the enhanced target profile 212 including at least one matched standardized data element.

In some embodiments, the data enhancement controller 106 may be in communication with a machine learning, or artificial intelligence, computing device. In this embodiment, the machine learning device may utilize artificial intelligence in order to suggest alterations or alter the user selectable options to result in increased success rates for the acquisition requests.

While the disclosure has described using the systems and methods of data enhancement for use in the mineral rights sector, the disclosure is not so limited and it should be appreciated that the systems and methods may be used for other purposes in marketing and customer contact outside of mineral rights acquisition.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the embodiments described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g. an EEPROM). Further, different parts of the computer software can be executed by different devices, such as, for example, in a client-server relationship. Persons skilled in the art will appreciate that computer software provides a series of instructions executable by the processor.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electronic system for enhancing data, comprising:
a display device;
a user input interface;
a data enhancement controller;
a tangible, non-transitory, computer readable storage medium, storing instructions, which, when executed by the data enhancement controller, cause the data enhancement controller to:
retrieve a root record of a target data subject, the root record including at least one core data element;
query a remote database of enhanced data elements using an electronic communication device configured to provide secure access to the remote database;
create an enhanced target profile including the root record and at least one of the enhanced data elements;
display, on the display device, the enhanced target profile;
display, at least one user selectable option for communicating an acquisition request to the target data subject using the enhanced target profile.

2. The system according to claim 1, wherein the core data element includes at least a mineral rights record.

3. The system according to claim 2, wherein the instructions further cause the data enhancement controller to iteratively compare the mineral rights record to the enhanced data elements, match at least one of the compared mineral rights record to the enhanced data elements and create the enhanced target profile including at least one matched data element.

4. The system according to claim 3, wherein the mineral rights record includes at least a physical location and the enhanced data elements include one or more of a social media identifier, an email address, an internet behavior profile, and demographic data.

5. The system according to claim 1, wherein the remote database includes tax information associated with mineral rights owners.

6. The system according to claim 5, wherein the instructions further cause the data enhancement controller to modify the root record to include a standardized data element, compare the standardized data element to the enhanced data elements, match the standardized data element to the enhanced data elements and create the enhanced target profile including at least one matched data element.

7. The system according to claim 1, wherein the instructions further cause the data enhancement controller to receive a selected option from the user input device, and transmit the acquisition request using the enhanced target profile.

8. The system according to claim 8, wherein the instructions further cause the data enhancement controller to receive a success indicator from the user input device and modify a matching protocol used to match the root record to the enhanced data elements based upon the received success indicator.

9. A method of enhancing data, comprising:
providing an electronic database including a plurality of root records, each root record associated with a target data subject of a plurality of target data subjects;
executing an application program interface to query a remote electronic database, the remote electronic database storing a plurality of enhanced data elements;
match at least one of the root records to at least one enhanced data element of the plurality of enhanced data elements;
create an enhanced target profile including the root record and the at least one enhanced data element;
display, on an electronic display device, the enhanced target profile;
receive, at least one user selectable option for communicating an acquisition request to the target data subject using the enhanced target profile; and
communicate the acquisition request to the target data subject.

10. The method according to claim 9, wherein the acquisition request is an offer to purchase mineral rights of the target data subject.

11. The method according to claim 9, wherein the enhanced data elements include at least one of tax records, social media identifiers, email addresses, internet behavioral profiles and demographic information.

12. The method according to claim 9, further comprising performing a verification process to determine whether the plurality of root records contains one or more inaccurate data elements, and correcting the inaccurate data elements by modifying the root record to include data from the plurality of enhanced data elements.

13. The method according to claim 9, wherein the at least one received user selectable option includes one or more of an electronically transmitted text message, an email, a physically printed document and a telephone call.

14. The method according to claim 13, further comprising receiving a success indicator that indicates whether the target data subject accepted the acquisition request.

15. The method according to claim 13, further comprising an opt-in request from at least one of the target data subjects to receive additional mineral rights acquisition data.

16. The method according to claim 9, further comprising independently querying a plurality of different remote databases, and creating the enhanced data profile by including at least one enhanced data element from each of the plurality of remote databases.

17. The method according to claim 9, wherein the acquisition request includes an offer to buy, lease or license mineral rights.

18. The method according to claim 9, further comprising receiving a response from the plurality of target data subjects, and sorting the enhanced target profiles based upon the received responses.

19. A tangible, non-transitory, computer readable storage medium, storing instructions, which, when executed by a data enhancement controller, cause the data enhancement controller to:
retrieve a root record of a target data subject from an electronic database, the root record including at least one core data element;
query a remote database of enhanced data elements using an electronic communication device configured to provide secure access to the remote database;
create an enhanced target profile by modifying the root record to include at least one of the enhanced data elements;
display, on an electronic display device, the enhanced target profile;
display, on the electronic display device, at least one user selectable option for communicating an acquisition request to the target data subject using the enhanced target profile.

20. The computer readable storage medium according to claim 19, wherein the acquisition request is an offer to purchase mineral rights of the target data subject.
